(19) United States
(12) Patent Application Publication
(10) Pub. No.: US 2012/0084162 A1
(43) Pub. Date: Apr. 5, 2012

(54) Systems and methods for conducting a composite bill payment transaction

(76) Inventors: Merrill Brooks Smith, Fort Lauderdale, FL (US); Phillip Craig Graves, Atlanta, GA (US); Phil M. Chakiris, Atlanta, GA (US)

(21) Appl. No.: 12/924,792

(22) Filed: Oct. 5, 2010

(51) Int. Cl. G06Q 20/00

(52) U.S. Cl. 705/16; 235/375

(57) ABSTRACT

The present invention is directed to systems and methods of conducting a payment system, facilitated between a computerized processor, a point-of-sale, a customer, and one or more payees to whom the customer wishes to make a payment. The method including the steps of: receiving composite payment transaction information from the customer—including identifying information of the one or more payees and an indication of the an amount of value the customer wishes to pay to each of the one or more payees, associating an identifier with the composite payment transaction information, providing the identifier to the customer, receiving the identifier from the point-of-sale, receiving an amount of value from the point-of-sale, and providing value to the one or more payees in the amount indicated by the customer in the composite payment transaction information. The system configured to provide payment in a similar manner.

### BACKGROUND OF THE INVENTION

The present invention is generally directed to systems and methods for conducting bill pay transactions. Specifically, the present invention is directed to systems and methods of paying one or more payees utilizing an identifier that is representative of the composite payment transaction at a point-of-sale.

It is well known for customers to purchase goods or services either upfront (prepaid), or on credit and later receive a bill from the provider of goods or services requesting payment (post-paid). The customer typically provides value to the provider of goods or services—or payee—through the use of a check drawn on a bank account, a credit or debit card, wire transfer, or via money order or Western Union.

More recently, online payment systems have evolved which generally allow a customer to access his or her bank account and schedule individual payments, or transfers, from the customer's account to identified payees. However, such systems require the customer have an operating bank account; meanwhile the unbanked segment of the population continues to grow.

Additionally, many providers offer online payment platforms. These payment platforms often receive value from bank accounts, or from credit or debit cards. However, a customer must individually access each provider's payment platform each month (or other payment cycle) to make the required payment.

There are numerous bill payment programs and plans, ranging from recurring payment plans linked to a financial account of a customer to online bill pay offered by most major banking institutions. Such bill pay systems are often focused at the unbanked segment of the population, and may provide a more efficient and inexpensive method of paying bills than prior art methods such as money orders or Western Union.

Accordingly, it is desirable to provide systems and methods of conducting bill pay transactions that do not require the customer to have a bank account, credit card, or money order—and are more convenient and easy than conducting multiple payment transactions.

### SUMMARY OF THE INVENTION

Aspects of the invention may include a computer implemented method of managing a payment system, the method conducted by a computerized processor and facilitated between the processor, a point-of-sale, a customer, and one or more payees to whom the customer wishes to make a payment, the processor being in selective communication with the point-of-sale, the customer, and the one or more payees, the method comprising: receiving composite payment transaction information from the customer, comprising: identifying information of the one or more payees; and an indication of the an amount of value the customer wishes to pay to each of the one or more payees; associating an identifier with the composite payment transaction information; providing the identifier to the customer; receiving the identifier from the point-of-sale; receiving an amount of value from the point-of-sale; and providing value to the one or more payees in the amount indicated by the customer in the composite payment transaction information.

Additional aspects of the invention may include a computer implemented method of managing a payment system, the method conducted by a computerized processor and facilitated between the processor, a point-of-sale, a customer, and one or more payees to whom the customer wishes to make a payment, the processor being in selective communication with the point-of-sale, the customer, and the one or more payees, the method comprising: receiving composite payment transaction information from the customer, comprising: information sufficient to identify the one or more payees; information sufficient to identify an account of the customer with the one or more payees; and an indication of the an amount of value the customer wishes to pay to each of the one or more payees; uniquely associating an identifier with the composite payment transaction information; providing the identifier to the customer in a machine-readable format; receiving the identifier from the point-of-sale; confirming that the identifier is valid and that the point-of sale is authorized to conduct the composite payment transaction; receiving an amount of value from the point-of-sale; providing value to the one or more payees in the amount indicated by the customer in the composite payment transaction information; and sending a confirmation to the customer confirming that value has been sent to the one or more payees.

Additional aspects of the present invention may include a processor for managing a payment system facilitated between a point-of-sale, a customer, and one or more payees to whom the customer wishes to make a payment, comprising: a customer interface that provides selectable communication between the processor and the customer, the customer interface configured to receive from the customer composite payment transaction information, comprising: information sufficient to identify the one or more payees; information sufficient to identify an account of the customer with the one or more payees; and an indication of the an amount of value the customer wishes to pay to each of the one or more payees; the customer interface configure to transmit to the customer an identifier uniquely associated with the composite payment transaction information; a point-of-sale interface that provides selectable communication between the processor and the point-of-sale, the point-of-sale interface configured to receive from the point-of-sale the identifier and confirmation that payment was received from the customer; a payee interface that provides selectable communication between the processor and the one or more payees, the payee interface configured to communicate with the one or more payees to confirm that the composite payment transaction information is accurate and transmit to the one or more payees value; and a processing module in communication with the customer interface, the point-of-sale interface, and the payee interface, the processing module configured to: uniquely associate an identifier with the composite payment transaction information received from the customer; provide the identifier to the customer in a machine-readable format; confirm that the identifier is valid and that the point-of sale is authorized to conduct the composite payment transaction; and determine an allocation of value to provide to each of the one or more payees.

These and other aspects will become apparent from the following description of the invention taken in conjunction with the following drawings, although variations and modifications may be effected without departing from the spirit and scope of the novel concepts of the invention.

### BRIEF DESCRIPTION OF THE DRAWING

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates a method of conducting one or more payment transactions using a single identifier, in accordance with some embodiments of the present invention.

FIG. 2 illustrates a method of conducting one or more payment transactions using a single identifier, in accordance with some embodiments of the present invention.

FIG. 3 illustrates a method of conducting one or more payment transactions using a single identifier, in accordance with some embodiments of the present invention.

FIG. 4 illustrates a method of conducting one or more payment transactions using a single identifier, in accordance with some embodiments of the present invention.

FIG. 5 depicts a system for conducting one or more payment transactions using a single identifier, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular. Reference figures preceded with “S” (e.g., S100) indicates a step.

In general, the systems and methods discussed below are directed to a bill pay system in which a customer access a processor (for example, via a computer and a website) and provides bill payment information (such as the identity of the provider, the customer's account number, and the amount of desired payment). The customer may enter bill payment information for multiple payment transactions—for example prepaid bills, postpaid bills, or even value transfers to identified payees unrelated to existing bills or debits. Following receipt of various transaction information, the processor may return to the customer an identifier. For example, the processor may return the identifier to a computer used by the customer for printing, it may send the identifier to an electronic device of the customer such as a mobile telephone or device, or may provide the identifier to the customer in any other way, such as encoding the identifier on a magnetic stripe. The identifier may be associated with the composite payment transaction information, meaning it is associated with each payment transaction—and accordingly each payee identity and amount—provided by the customer.

The identifier may be in any form, including alpha characters, numbers, alpha-numeric characters, machine readable format, etc. The identifier may be provided in bar code format, QR code, an encoded magnetic stripe, an encoded radio frequency identification (RFID) tag, etc. Moreover, the identifier may be recognizable, in whole or in part, by a POS. For example, the identifier may comprise a stock keeping unit (SKU) or universal price code (UPC) that inform the POS of the amount due from the customer or the composite payment transaction. This amount may include taxes, fees, and additional charges.

The customer may then present the identifier to an authorized or acceptable POS. The identifier may presented during a standard in-lane transaction. In other words, the customer may purchase additional goods or services and conduct the bill payment transaction concurrently. The POS may receive the identifier (either by reading the identifier or by having it entered by the customer or by a clerk). In some cases the POS may recognize from the identifier the total amount due and may add this amount to the cost of any other additional purchased goods or services. In some cases the POS may recognize the identifier and route the identifier to the processor, and receive from the processor the total amount for the composite payment transaction.

The POS may then add the cost of the composite payment transaction to any other in-lane purchases, and request payment from the customer. The customer may pay the POS in any manner accepted by the POS, which may include cash, credit, money orders, stored value, etc.

The processor receives the identifier and may conduct the constituent payment transactions of the composite payment transaction information. Once payment has been made to the identified payees, the processor may return a confirmation to the POS, which in turn may pass the confirmation to the customer. The processor may later settle-up with the POS for the costs of the payment transaction.

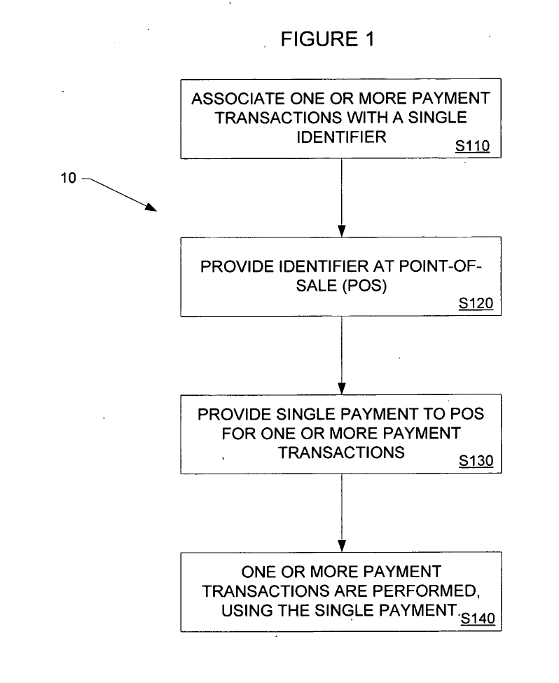

With reference to FIG. 1, a method 10 of conducting one or more payment transactions using a single identifier, in accordance with some embodiments of the present invention will now be discussed. At S110 one or more payment transactions are associated with a single identifier. These payment transactions may be for prepaid or post-paid accounts, or may be for single-time value transfers (for example, purchase such as on e-Bay), or may be entirely unrelated to goods or services (for example, transferring value to a student or a friend for his or her birthday). The association may require specific information such as the amount of value to transfer, the identity of the party receiving the value (i.e., the payee), and if applicable, identification of the customer account with the payee. The multiple payment transactions associated with the identifier create a composite payment transaction, and accordingly the information associated with the multiple payment transactions associated with the identifier create the composite payment transaction information.

At S120 the identifier may be provided at a POS. The identifier may be in any number of format, and the provision of the identifier to the POS may be somewhat dependent upon the format of the identifier. For example, if the identifier is provided in bar code or QR code format, the identifier may be read by a bar code reader connected to the POS. If the identifier is provided in a magnetic stripe, a magnetic stripe reader may be utilized. Similarly, if the identifier is provided on a RFID tag, an RFID interrogator may be used. If the identifier is provided in an alpha, numeric, or alphanumeric format, the identifier may be entered by the customer or a clerk, or may be recognized by the POS via a optical character recognition program or if an E13B font is used, read with Magnetic Ink Character Recognition.

A S130 the customer may provide a single payment for the composite payment transaction. The amount of value provided by the customer may include the combined cost of the payments, as well as any applicable fees, taxes, commissions, etc. This value may be provided to the POS in any manner value is accepted by the POS, for example via cash, check, credit cards, debit cards, stored value cards, etc.

At S140 the one or more payment transactions are performed. The composite payment transaction information is utilized to conduct each of the constituent payment transactions.

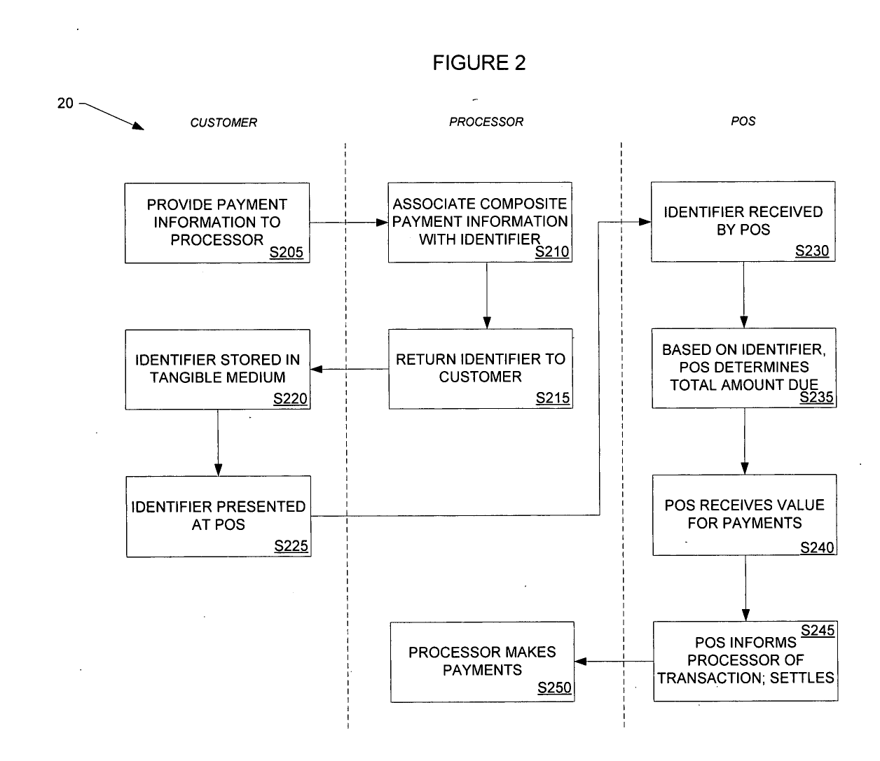

With reference to FIG. 2, a method 20 of conducting one or more payment transactions using a single identifier, in accordance with some embodiments of the present invention will now be discussed. For exemplary purposes, FIG. 2 indicates which party—the customer, processor, or POS—may perform each step. However, it is fully contemplated that the steps listed may be performed by any of the three parties, as well as by any additional parties. Moreover, it is fully contemplated that additional steps may be conducted by the any of the three parties, as well as by an any additional parties.

At S205 the customer may provide payment information to the processor. The customer may provide this payment information in any number of ways, including for example via a computer on the Internet or any other communication network; via a mobile device such as a mobile telephone, smartphone, or PDA; via a telephone call with either a live operator or interactive voice recognition (IVR) unit; or via a kiosk or dedicated terminal. The payment information may comprise the information necessary to conduct the payment transaction, such as information sufficient to identify the payee, information sufficient to identify a particular account with the payee, information sufficient to identify the customer, and any other information that may be needed or required to make such payments. This information comprises the composite payment information.

At S210 the processor may receive the information and may associate an identifier with the composite payment information. The identifier may be uniquely identified with the composite payment information, meaning that identical identifiers may not be used (at least, not used in a manner that may cause confusion; reuse over a large time frame, or with other constraints such as acceptable POS, payees, or mechants, or geographic areas, may be acceptable).

At S215 the identifier may be returned to the customer. As noted above, the identifier the identifier may be in any number of format, and the provision of the identifier to the POS may be somewhat dependent upon the format of the identifier. For example, if the identifier is provided in bar code or QR code format, the identifier may be read by a bar code reader connected to the POS. If the identifier is provided in a magnetic stripe, a magnetic stripe reader may be utilized. Similarly, if the identifier is provided on a RFID tag, an RFID interrogator may be used. If the identifier is provided in an alpha, numeric, or alphanumeric format, the identifier may be entered by the customer or a clerk, or may be recognized by the POS via a optical character recognition program or if an E13B font is used, read with Magnetic Ink Character Recognition.

At S220 the customer may store the identifier in a tangible medium. For example, the identifier may be returned to the customer in the form of a bar code, but the customer may be required to print the bar code. As another example, the identifier may be in the form of a QR code sent to the customer's mobile telephone or device, and the customer may be required to save the identifier.

At S225 the customer provides the identifier to a POS. The POS may be any standard point-of-sale terminal or device. At S230 the POS receives the identifier. The method of receiving the identifier may be based on the format of the identifier. At S235 the POS may determine the total amount due for the payment transaction (plus any applicable taxes, fees, charges, or commissions). The POS may make this determination based upon the identifier comprising a price code recognizable by the POS—for example an SKU or UPC.

At S240 the POS may receive value from the customer for the composite payment transaction. At S245 the POS may inform the processor of the transaction and provide the identifier to the processor. The POS and the processor may settle, either at that time or during a regular periodic settlement.

At S250 the processor makes the payments that formed the composite payment transaction. The processor may determine the constituent payment transactions by referencing the information received from the customer that was associated with the identifier at S210.

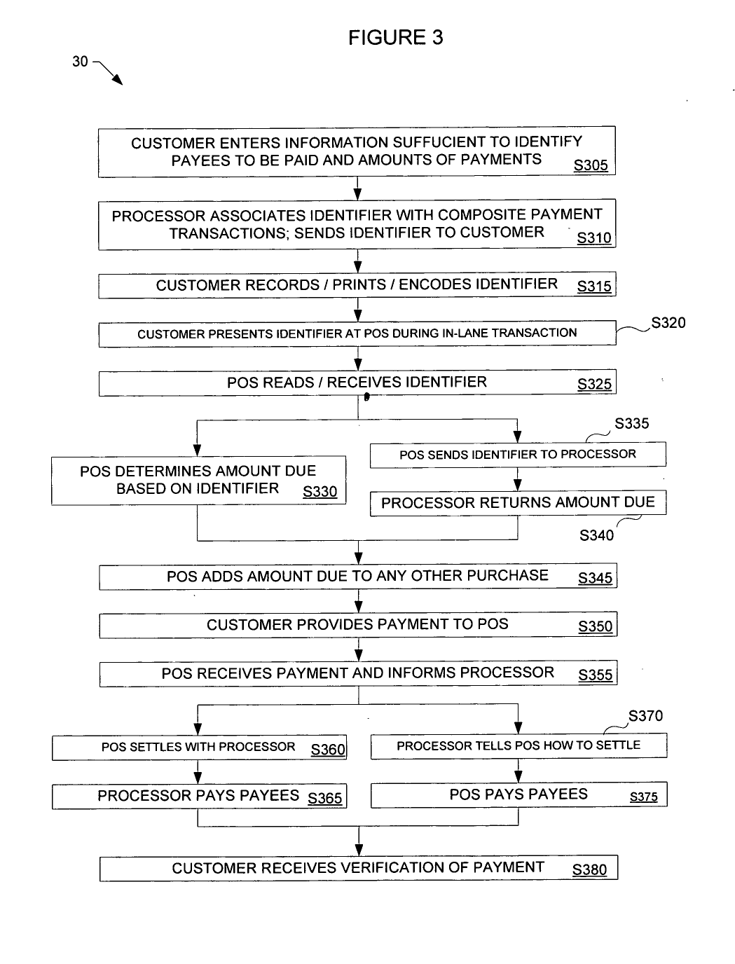

With reference to FIG. 3, a method 30 of conducting one or more payment transactions using a single identifier, in accordance with some embodiments of the present invention will now be discussed. FIG. 3 provides a slightly more detailed process.

At S305 the customer may enter information sufficient to identify the payees, amounts of payments, and any other information needed for payment (such as account information, or customer identification information). The information for each individual payment to be made forms the composite payment transaction information. At S310 the processor may receive this information, and may associate an identifier with the composite payment transaction information. The identifier may be provided to the customer in any of the formats discussed above with regard to FIG. 1 or 2.

At S315 the customer may record, print, encode, or save the identifier. In this manner, the customer may bring the identifier with the customer for use during a transaction at a POS. The transaction at the POS may occur at a later time.

At S320, the customer may present the identifier to the POS. At S325 the POS may read or receive the identifier. The method of reading or receiving the identifier may be based upon the format of the identifier.

Depending on the type of identifier, the relationship between the POS and processor, or any other circumstance, at least two paths may be taken. First, at S330 the POS may determine the amount owed for the composite payment transaction (including any fees, taxes, charges or commissions) based upon the identifier itself. For example, this may occur if the identifier comprises a SKU or UPC.

Alternatively, at S335 the POS may send the identifier to the processor. The POS may know to send the identifier to the processor via any number of manners, including the use of specific platform programming or the use of specific issuer identification numbers (IINs). At S340 the processor may determine the amount due for the composite payment transaction, and may return this amount to the POS.

At S345 the POS may add the amount due for the composite payment transaction to the amount required for the purchase of any other goods or services. Accordingly, the composite payment transaction may occur in-lane along with the purchase of other goods or services. For example, a customer may associate the information, print a bar code, go to a retailer and select groceries. During check-out the customer may present—in addition to the groceries selected for purchase—the identifier. The cost of the composite payment transaction may be added to the cost of the selected groceries.

At S350 the customer may provide payment to the POS. The POS may receive payment in any manner accepted by the POS, such as cash, credit cards, debit cards, check, or stored value cards.

At S355 the POS may receive payment, confirm it is valid, and inform the processor of the transaction. Again depending on the type of identifier, the relationship between the POS and processor, or any other circumstance, at least two paths may be taken. At S360 the POS may settle with the processor, and at S365 the processor may pay the payees. The processor knows which payees to pay and how much to pay based upon the information received from the customer at S305. Alternatively, at S370 the processor may inform the POS how to settle with each payee (e.g., the identity of the payees and the amounts of payment), and at S375 the POS may pay the payees.

At S380 the customer may receive verification of payment.

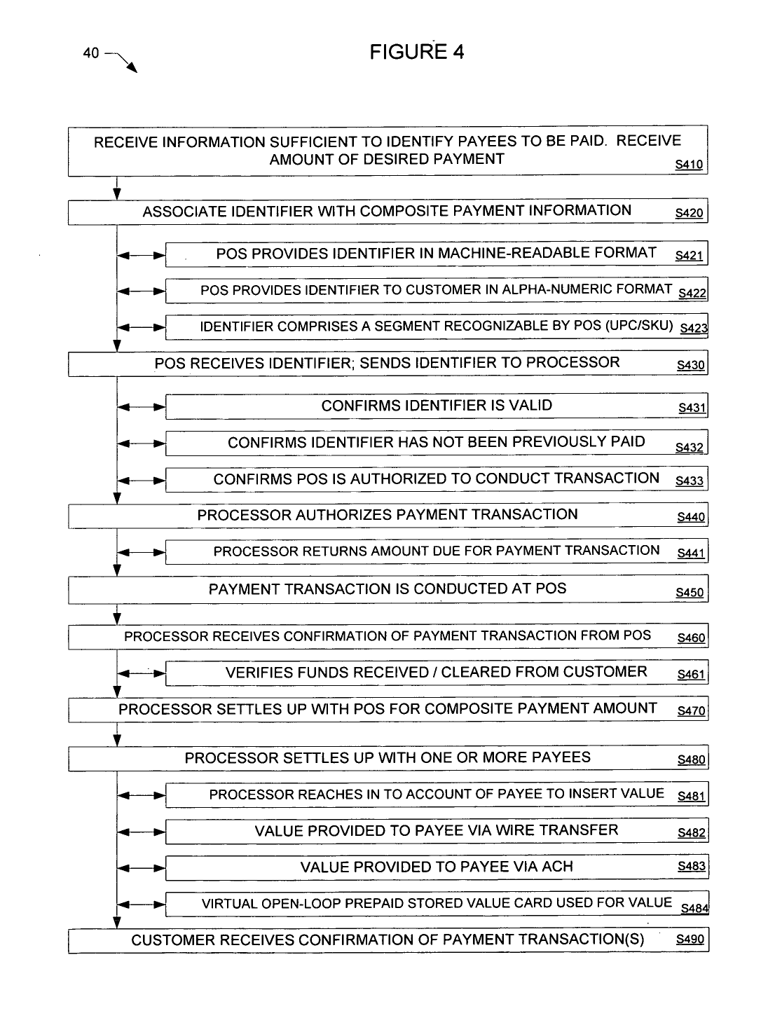

With reference to FIG. 4, a method 40 of conducting one or more payment transactions using a single identifier, in accordance with some embodiments of the present invention will now be discussed. FIG. 4 outlines some variations and steps that may be included in the overall process.

At S410 the POS may receive information sufficient to make payments, e.g., information sufficient to identify payees to paid and the amount of payments. This information may form composite payment information. At S420 the processor may associate an identifier with the composite payment information. The identifier may be in various formats. At S421 the identifier may be in machine-readable format. At S422 the identifier may be in alphanumeric format. At S423 the identifier may comprise a segment recognizable by a POS—such as a SKU or UPC.

At S430 the POS may receive the identifier and may send the identifier to the processor. The processor may at S431 confirm that the identifier is valid; confirm at S432 that payment has not already been received for the composite payment transaction associated with the identifier; and/or confirm at S433 that the POS is authorized to conduct the composite payment transaction.

At S440 the processor may authorize the composite payment transaction, and at S441 the processor may inform the POS of the amount due for the composite payment transaction.

At S450 the composite payment transaction may be conducted at the POS. At S460 the processor may receive confirmation that the composite payment transaction was conducted, and at S461 the processor may confirm that funds were received from the customer, and/or that funds cleared.

At S470 the processor may settle with the POS for the composite payment amount, less any fees or costs due to the POS.

At S480 the processor may settle with the one or more payees that were identified in the composite payment transaction information. The processor may settle with the payees in any number of ways, including at S481 reaching into an account of the payee to directly insert value, at S482 transferring value to the payee via wire transfer, at S483 providing value to the payee via the automated clearing house system, or at S484 providing to the payee a virtual prepaid stored value card number, funded with the amount of payment to the particular payee.

At S490 the customer may receive confirmation of the payment transaction. If there are any issues and the one or more of the constituent payments to specific payees cannot be conducted, the processor may provide to the customer an indicia redeemable for the value not transferred. For example, the processor may provide to the customer a virtual prepaid stored value card number for use in various transactions. Alternatively, the processor may carry such funds until a subsequent payment transaction selected by the customer.

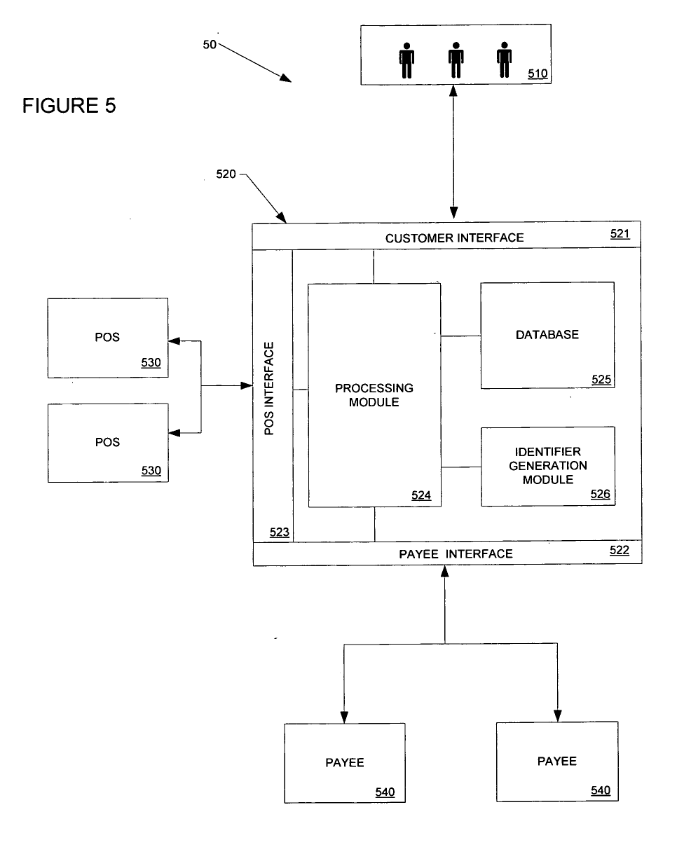

With reference to FIG. 5, a system 50 for conducting one or more payment transactions using a single identifier, in accordance with some embodiments of the present invention will now be discussed. The system 50 may comprise one or more customers 510, a processor 520, one or more POSs 530, and one or more payees 540.

The processor 520 may comprise a customer interface 521, a payee interface 522, a POS interface 523, a processing module 524, a database 525, and an identifier generation module 526. The customer interface 521 may handle all incoming and outbound communications with the one or more customers 510. Because customers may access the processor in various manners (e.g., via the Internet, applications, applets, text messaging (SMS/MMS), electronic mail, telephone calls, etc.), the customer interface 521 may collectively identify a plurality of interfaces with different customers.

The payee interface 522 may handle all incoming and outbound communications with various payees, the payment platforms of payees, or parties designated by payees to receive funds on the payees behalf. In some embodiments, the payee interface 522 may take the form of an interface on a host-to-host network. Because each payee may have different requirements or system characteristics, payee interface 523 may collectively identify a plurality of interfaces with different payees. In some embodiments, the processor 520 may access the payee 540 such that the processor 520 may determine the amount owed by the customer 510 to the payee 540. The processor 520 may inform the customer 510 of this amount during determination of the composite payment transaction information.

The POS interface 523 may handle all incoming and outbound communications with various POS devices, locations, or merchants. In some embodiments, the POS interface 523 may take the form of an interface on a host-to-host network. Because each POS may have different requirements or system characteristics, POS interface 523 may collectively identify a plurality of interfaces with different POSs.

The processing module 524 may be coupled to the various interfaces (521, 522, 523), as well as to the database 525 and the identifier generation module 526. The processing module may perform all determinations, computations, and processing required to conduct the various payment transactions. For example, the processing module may uniquely associate an identifier with the composite payment transaction information received from the customer, provide the identifier to the customer in a machine-readable format, confirm that the identifier is valid and that the point-of sale is authorized to conduct the composite payment transaction, and determine an allocation of value to provide to each of the one or more payees.

The database may comprise various records associated with the composite payment transaction. These records may include associate identifiers generated by the identifier generation module 526 with the customer, the identity of the payees, customer account information with the payees, and/or payment amount information. The database may store this information to make future periodic payments more efficient and convenient.

The identifier generation module 526 may generate unique or semi-unique identifiers associated with each set of composite payment transaction information. The identifiers may be semi-unique in that the identifiers may be unique in a sub-set of identifiers, based upon characteristics such as, but not limited to, geographic location or scope, acceptable or authorized POS or merchants, specific payee identification, temporal limitations (e.g., identifiers may be periodically recycled), etc

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

What is claimed is:

1. A computer implemented method of managing a payment system, the method conducted by a computerized processor and facilitated between the processor, a point-of-sale, a customer, and one or more payees to whom the customer wishes to make a payment, the processor being in selective communication with the point-of-sale, the customer, and the one or more payees, the method comprising:
receiving composite payment transaction information from the customer, comprising:
identifying information of the one or more payees; and
an indication of the an amount of value the customer wishes to pay to each of the one or more payees;
associating an identifier with the composite payment transaction information;
providing the identifier to the customer;
receiving the identifier from the point-of-sale;
receiving an amount of value from the point-of-sale;
providing value to the one or more payees in the amount indicated by the customer in the composite payment transaction information.

2. The method of claim 1, wherein the identifying information of the one or more payees comprises:
information sufficient to identify the one or more payees; and
information sufficient to identify an account of the customer with the one or more payees.

3. The method of claim 1, wherein the identifier is uniquely associated with the composite payment transaction information.

4. The method of claim 1, wherein the identifier is provided to the customer in a machine-readable format.

5. The method of claim 4, wherein the machine readable format is a bar code.

6. The method of claim 5, wherein the bar code comprises information determinable by the point-of-sale to indicate a total value due from the customer for the composite payment transaction.

7. The method of claim 6, wherein bar code comprises a universal price code (UPC) or stock keeping unit (SKU).

8. The method of claim 4, wherein the machine readable format is selected from the group consisting of: a QR code, a magnetic stripe, and a radio frequency identification (RFID) tag.

9. The method of claim 6, wherein the total value due from the customer for the composite payment includes fees, taxes, commissions, or additional charges.

10. The method of claim 1, wherein the step of receiving the identifier from the point-of-sale comprises receiving a second identifier associated with the identifier.

11. The method of claim 1, wherein value is provided to the one or more payees via automated clearing house (ACH) settlement.

12. The method of claim 1, wherein value is provided to the one or more payees via wire transfer.

13. The method of claim 1, wherein value is provided to the one or more payees via the processor reaching into a database or account of the one or more payees and inserting value.

14. The method of claim 1, wherein value is provided to the one or more payees by transmitting to the one or more payees an indicia associated with a virtual prepaid stored value card.

15. The method of claim 1, wherein the one or more payees is a provider of goods or services to whom the customer owes money for an unpaid bill.

16. The method of claim 1, further comprising confirming to the customer that value has been sent to the one or more payees.

17. The method of claim 1, wherein the step of providing value to the one or more payees in the amount indicated by the customer in the composite payment transaction information comprises informing the point-of-sale how to distribute the value received with the one or more payees.

18. The method of claim 1, further comprising the step of confirming that the identifier is valid.

19. The method of claim 1, further comprising the step of confirming that a composite payment transaction associated with the identifier has not been previously conducted.

20. The method of claim 1, further comprising the step of confirming that the point-of-sale is authorized to request the composite payment transaction.

21. The method of claim 1, further comprising the step of the processor sending to the point-of-sale the total amount due for the composite payment transaction.

22. The method of claim 1, wherein the step of providing value to the one or more payees in the amount indicated by the customer in the composite payment transaction information is not performed until it is confirmed that value has been actually received by the point-of-sale from the customer.

23. A computer implemented method of managing a payment system, the method conducted by a computerized processor and facilitated between the processor, a point-of-sale, a customer, and one or more payees to whom the customer wishes to make a payment, the processor being in selective communication with the point-of-sale, the customer, and the one or more payees, the method comprising:
receiving composite payment transaction information from the customer, comprising:
information sufficient to identify the one or more payees;
information sufficient to identify an account of the customer with the one or more payees; and
an indication of the an amount of value the customer wishes to pay to each of the one or more payees;
uniquely associating an identifier with the composite payment transaction information;
providing the identifier to the customer in a machine-readable format;
receiving the identifier from the point-of-sale;
confirming that the identifier is valid and that the point-of sale is authorized to conduct the composite payment transaction;
receiving an amount of value from the point-of-sale;
providing value to the one or more payees in the amount indicated by the customer in the composite payment transaction information; and
sending a confirmation to the customer confirming that value has been sent to the one or more payees.

24. A processor for managing a payment system facilitated between a point-of-sale, a customer, and one or more payees to whom the customer wishes to make a payment, comprising:
a customer interface that provides selectable communication between the processor and the customer, the customer interface configured to receive from the customer composite payment transaction information, comprising:
information sufficient to identify the one or more payees;
information sufficient to identify an account of the customer with the one or more payees; and
an indication of the an amount of value the customer wishes to pay to each of the one or more payees;
the customer interface configure to transmit to the customer an identifier uniquely associated with the composite payment transaction information;
a point-of-sale interface that provides selectable communication between the processor and the point-of-sale, the point-of-sale interface configured to receive from the point-of-sale the identifier and confirmation that payment was received from the customer;
a payee interface that provides selectable communication between the processor and the one or more payees, the payee interface configured to communicate with the one or more payees to confirm that the composite payment transaction information is accurate and transmit to the one or more payees value; and
a processing module in communication with the customer interface, the point-of-sale interface, and the payee interface, the processing module configured to:
uniquely associate an identifier with the composite payment transaction information received from the customer;
provide the identifier to the customer in a machine-readable format;
confirm that the identifier is valid and that the point-of sale is authorized to conduct the composite payment transaction; and
determine an allocation of value to provide to each of the one or more payees.

25. The processor of claim 24, further comprising a database.

26. The processor of claim 25, wherein the database comprises records of the composite transaction information, the records associating the identifier therewith.

27. The processor of claim 25, wherein the database comprises records associated with a customer for use in future composite payment transactions.

28. The processor of claim 24, further comprising an identifier generation module for generating an identifier representative of the composite payment transaction.

29. The processor of claim 28, wherein the identifier generation module generates an identifier in a machine-readable format.

30. The processor of claim 29, wherein the machine readable format is a bar code.

31. The processor of claim 30, wherein the bar code comprises information determinable by the point-of-sale to indicate a total value due from the customer for the composite payment transaction.

32. The processor of claim 30, wherein bar code comprises a universal price code (UPC) or stock keeping unit (SKU).

33. The processor of claim 29, wherein the machine readable format is selected from the group consisting of: a QR code, a magnetic stripe, and a radio frequency identification (RFID) tag.
